(19) United States
(12) Patent Application Publication
(10) Pub. No.: US 2015/0245291 A1
(43) Pub. Date: Aug. 27, 2015

(54) METHOD AND APPARATUS FOR POWER EFFICIENT DOWNSTREAM COMMUNICATION IN SENSOR NETWORKS

(71) Applicant: QUALCOMM Incorporated, San Diego, CA (US)

(72) Inventors: Jangwon LEE, San Diego, CA (US); Richard Oliver FARLEY, San Diego, CA (US); Gang DING, San Diego, CA (US)

(73) Assignee: QUALCOMM Incorporated, San Diego, CA (US)

(21) Appl. No.: 14/192,617

(22) Filed: Feb. 27, 2014

(51) Int. Cl. H04W 52/02; H04W 4/00

(52) U.S. Cl. CPC H04W 52/0222; H04W 4/005

(57) ABSTRACT

Methods and apparatuses are described for asynchronous communications in a sensor network. An indication of a receiving opportunity can be transmitted by a sensor device. The sensor device can then provide the receiving opportunity based at least in part on transmitting the indication, and disable communication resources at the sensor device for a duration of a sleep time following the receiving opportunity. An upstream node can generate information for communicating to a sensor device, receive the indication of the receiving opportunity from the sensor device, and transmit the information to the sensor device during the receiving opportunity based at least in part on receiving the indication.

### BACKGROUND

Advances in hardware and wireless network technologies have led to creation of low-cost, low-power, multifunctional sensor devices of varying sizes and functionalities. Sensor devices can include, or can be employed by, various consumer products or other devices to facilitate communicating data with one or more nodes over a wireless network, where the communications can relate to status or health data of the product, parameters for configuring or controlling the product, and/or the like. Many sensor devices are small in size and operate independently of a fixed power source, such as by battery power. Moreover, due to the small size, the battery may be small as well, such as a coin-cell battery, and/or may not be replaceable or rechargeable in many cases. Thus, saving power consumption at the sensor device can be a paramount concern in sensor networks.

In current sensor network configurations, sensor devices (also known as leaf nodes) may be constantly or frequently tuned to receive communications from upstream nodes (such as relay nodes, sink nodes, etc.), as the sensor devices do not know when the upstream nodes will transmit data to the sensor devices. Listening and also receiving communications from the upstream nodes can result in a majority, or at least a significant portion, of power consumption at the sensor devices (e.g., as compared to transmitting and/or other operations). In Bluetooth Low Energy (BLE) technology, which is used for communicating by some sensor devices, transmitting typically requires power on the order of 10 milliamperes (mA) while receiving typically requires power on the order of 20 mA. In addition, in BLE, a duration for transmitting is typically on the order of 7 milliseconds, while a duration for receiving is usually much longer since the sensor device may wish to receive packets from other nodes. Some attempts at sensor device power conservation reduce receiving durations and/or periodicity at the sensor devices in an attempt to conserve power, but as receiving opportunities are reduced, delay and/or errors can become more prevalent in the communications.

Thus, improvements in sensor devices and sensor networks are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with some aspects, a method for communicating in a sensor network is provided. The method includes transmitting an indication of a receiving opportunity at a sensor device, providing the receiving opportunity at the sensor device based at least in part on transmitting the indication, and disabling communication resources at the sensor device for a duration of a sleep time following the receiving opportunity.

In accordance with some aspects, an apparatus for communicating in a sensor network is provided. The apparatus includes an indication transmitting component operable for transmitting an indication of a receiving opportunity at a sensor device, a receiving opportunity providing component operable for providing the receiving opportunity at the sensor device based at least in part on the indication transmitting component transmitting the indication, and a resource disabling component operable for disabling communication resources at the sensor device for a duration of a sleep time following the receiving opportunity.

In accordance with some aspects, another method for communicating in a sensor network is described. This method includes generating information for communicating to a sensor device, receiving an indication of a receiving opportunity from the sensor device, and transmitting the information to the sensor device during the receiving opportunity based at least in part on receiving the indication.

In accordance with some aspects, an apparatus for communicating in a sensor network is described. The apparatus includes an information providing component operable for generating information for communicating to a sensor device, an indication receiving component operable for receiving an indication of a receiving opportunity from the sensor device, and a communications component operable for transmitting the information to the sensor device during the receiving opportunity based at least in part on receiving the indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example sensor network, in accordance with various disclosed aspects;

FIG. 2 depicts an example sensor network including a sensor device that communicates with an upstream node, in accordance with various disclosed aspects;

FIG. 3 is a flowchart depicting an example method of transmitting an indication of a receiving opportunity at a sensor device;

FIG. 4 depicts an example sensor network including an upstream node that communicates with a sensor device, in accordance with various disclosed aspects;

FIG. 5 is a flowchart depicting an example method of receiving an indication of a receiving opportunity at a sensor device; and

FIG. 6 depicts example communication timelines for an upstream node and a sensor device, in accordance with various disclosed aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Aspects described herein relate to providing power efficient downstream communications in sensor networks without introducing significant receiving delays. In an example, a sensor device (e.g., a leaf node in a sensor network) can transmit communications to indicate a receiving opportunity at the sensor device, during which an upstream node may transmit information to the sensor device. The sensor device can then perform a sleep operation during which communication resources are powered down or at least power limited. By notifying of the receiving opportunity, the sensor device need not continuously or frequently attempt to receive communications in the sensor network and/or can lessen a duration of the receiving opportunity. Shortening the frequency and duration of the receiving opportunities at the sensor device can lessen power consumption at the device.

Additionally, in this example, when the upstream node (e.g., a relay node, sink node, etc.) is ready to transmit to the sensor device, the upstream node can await the transmission from the sensor device, and then can transmit to the sensor device during the related receiving opportunity. This transmission can occur immediately following receipt of the transmission from the sensor device and/or in a time period indicated in the transmission from the sensor device, etc. It is to be appreciated that the power required for the sensor device to transmit the indication of the receive opportunity and to subsequently perform the receive opportunity is less than that typically required of one or more receive opportunities without the indication, as such opportunities without the indication can require longer receive durations due to asynchronous communications between the sensor devices and upstream nodes.

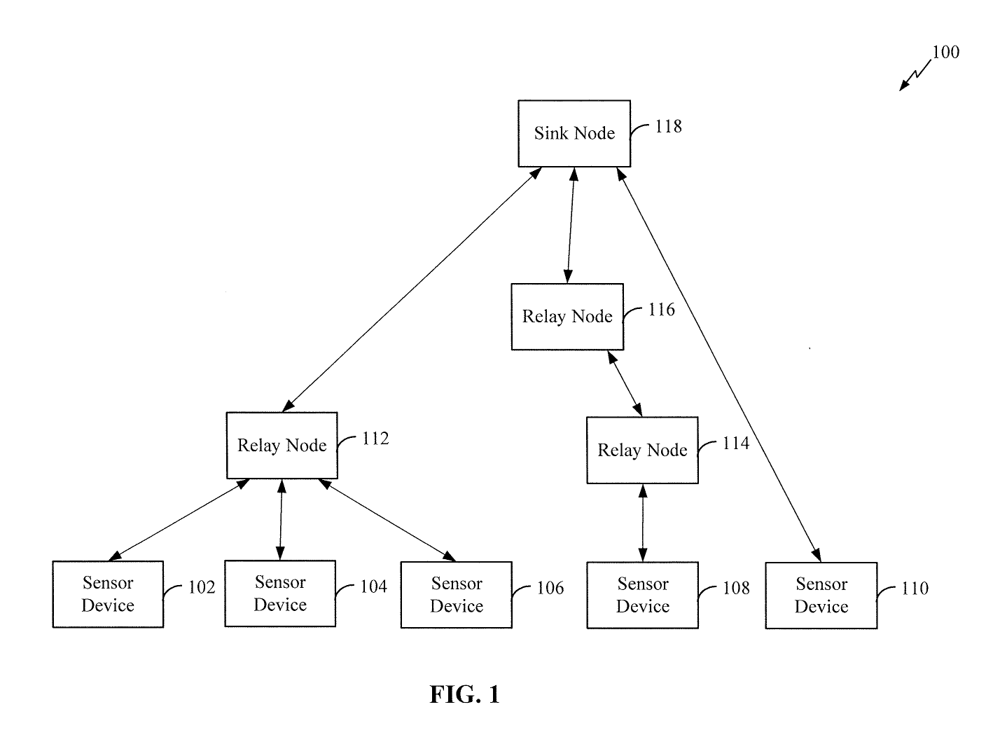

FIG. 1 illustrates an example sensor network 100 in accordance with aspects described herein. Sensor network 100 includes a plurality of sensor devices 102, 104, 106, 108, 110, that can communicate with one or more relay nodes 112, 114, 116, and/or a sink node 118. Relay nodes 112, 114, 116 can provide access to sink node 118, and/or sensor devices can communicate directly with sink node 118 (e.g., sensor device 110). Moreover, some sensor devices may communicate with sink node 118 through multiple relay nodes (e.g., sensor device 108 communicating with relay node 114, which communicates with relay node 116 to access sink node 118). It is to be appreciated, in this regard, that relay nodes 112, 114, 116 can provide one or more sensor devices and/or other relay nodes with access to sink node 118 and/or one or more relay nodes that communicate with sink node 118 (e.g., directly or via additional relay node(s)). The sink node 118 can include, for example, a base station or coordinator that communicates with the sensor devices 102, 104, 106, 108, 110. The sink node 118 can be secured with unlimited available energy while the sensor devices 102, 104, 106, 108, 110 may be unsecured with limited available energy, as described.

For example, in some deployments, sensor devices 102, 104, 106 may exist at a similar location (e.g., within a range of the relay node 112), and can communicate with relay node 112 using one or more wired or wireless communication mediums. In one example, sensor devices 102, 104, 106 can participate in a local area network (LAN) with relay node 112 such to facilitate communications therebetween. For example, the devices 102, 104, 106, and/or relay node 112 can communicate via a router, switch, hub, etc., an ad-hoc network, and/or the like accessed via a wired or wireless connection. In another example, device 102, 104, 106, and/or relay node 112 can communicate using a Bluetooth technology, which may include Bluetooth Low Energy (BLE), near-field communications, or substantially any peer-to-peer or ad-hoc wireless technology. Moreover, in an example, devices 102, 104, 106, and/or relay node 112 can communicate using cellular technologies, such as third generation partnership project (3GPP) defined technologies over one or more mobile networks. In any case, relay node 112 can act as a relay or gateway to sink node 118 for devices 102, 104, 106.

In a specific example, sensor devices 102, 104, 106, 108, 110 can operate in conjunction with appliances or other products. Sensor devices 102, 104, 106, 108, 110 can include temperature sensors, motion sensors, ambient light sensors, accelerometers, barometers, pressure sensors, audio sensors, wearable technology devices, and/or any device capable of measuring a physical quantity and convert it into an electronic signal of some kind (e.g., a temperature). In addition, sensor devices 102, 104, 106, 108, 110 can exist within specific products or appliances to allow monitoring and/or controlling of the products or appliances, such as within kitchen appliances, door locks, safety lighting, power circuits or outlets in electrical service, sporting goods, diapers, and/or substantially any product that can be monitored or controlled.

In this regard, for example, sensor devices 102, 104, 106, 108, 110 can transmit upstream communications to the sink node 118, via one or more relay nodes 112, 114, 116 or otherwise, where the upstream communications can include information such as health or status of the device 102, 104, 106, 108, 110 or the specific product or appliance to which the device relates, or information relating to what is sensed by the device. In addition, for example, devices 102, 104, 106, 108, 110 can receive downstream communications from the sink node 118 via one or more relay nodes 112, 114, 116, or otherwise, where the downstream communications can include information related to controlling the device 102, 104, 106, 108, 110 or its related specific product or appliance, configuring the device 102, 104, 106, 108, 110 or its specific product or appliance, and/or the like. In some cases, for example, sensor devices 102, 104, 106, 108, 110 may not always be within access of the sink node 118 (e.g., via one or more relay nodes or otherwise), and thus may not always be able to communicate therewith. This can mostly occur, for example, where the sensor device is, or is related to, a non-stationary device. In this example, the sensor device can communicate with the sink node 118 when within range of the node 118 or one or more relay or other nodes in the sensor network 100.

In any case, sensor devices 102, 104, 106, 108, 110 may operate under power limitations as these devices 102, 104, 106, 108, 110 may be battery-powered. Relay nodes 112, 114, 116 and sink node 118, however, may be powered using a power outlet or other power supply where power conservation is not as much of a concern as it is for battery-powered devices. In addition, sensor devices 102, 104, 106, 108, 110 may be relatively small such that battery size, and thus power capacity, is further limited. With the foregoing in mind, aspects presented herein aim to lower power utilization by the sensor devices 102, 104, 106, 108, 110 based on the sensor devices 102, 104, 106, 108, 110 indicating information regarding receiving opportunities at the devices by transmitting an indication to respective relay nodes 112, 114, 116 and/or sink node 118.

In this regard, sensor devices 102, 104, 106, 108, 110 need not operate to provide receiving opportunities at periodic intervals for long durations, as typically required by existing technologies so that transmissions from relay nodes 112, 114, 116, and/or sink node 118 are not missed. For example, in BLE, current typical transmission times can be on the order of 7 milliseconds and require around 10 milliamperes (mA) to be performed, whereas providing receiving opportunities can currently be for a larger duration and can require 20 mA or more. The larger duration may be due to typically asynchronous communications between the sensor devices 102, 104, 106, 108, 110 and their upstream nodes (e.g., relay node 112, 114, 116 and/or sink node 118).

Thus, to avoid providing such periodic and lengthy receiving opportunities, which can consume more power than transmitting, sensor devices 102, 104, 106, 108, 110 can transmit an indication of an upcoming receiving opportunity, where the receiving opportunity is of a relatively short duration, to the relay nodes 112, 114, 116, and/or sink node 118. When the relay nodes 112, 114, 116, and/or sink node 118 have information to transmit to the devices 102, 104, 106, 108, 110, the relay nodes 112, 114, 116, and/or sink node 118 can wait to receive the indication from sensor devices 102, 104, 106, 108, 110 and can transmit the information based on receiving the indication. Thus, the relay nodes 112, 114, 116, and/or sink node 118 acquire information as to an upcoming receiving opportunity at the sensor devices 102, 104, 106, 108, 110, and can thus transmit the information during the receiving opportunity.

Sensor devices 102, 104, 106, 108, 110 can transmit the indication and provide the corresponding receiving opportunity periodically, while disabling or otherwise lowering power consumption of communication resources when not transmitting the indication or providing the receiving opportunity. Because the relay nodes 112, 114, 116, and/or sink node 118 are notified of the receiving opportunity, the receiving opportunity can be shortened at the sensor devices 102, 104, 106, 108, 110 with the expectation that the relay nodes 112, 114, and/or sink node 118 are aware of the receiving opportunity and can send information during the shortened receiving opportunity if so desired. Thus, though additional power is utilized to transmit the indication, the power savings of the shortened receiving opportunity and of disabling or reducing power consumption of the communication resources when not transmitting or providing the receiving opportunity can result in an overall savings in power consumption at the sensor devices 102, 104, 106, 108, 110.

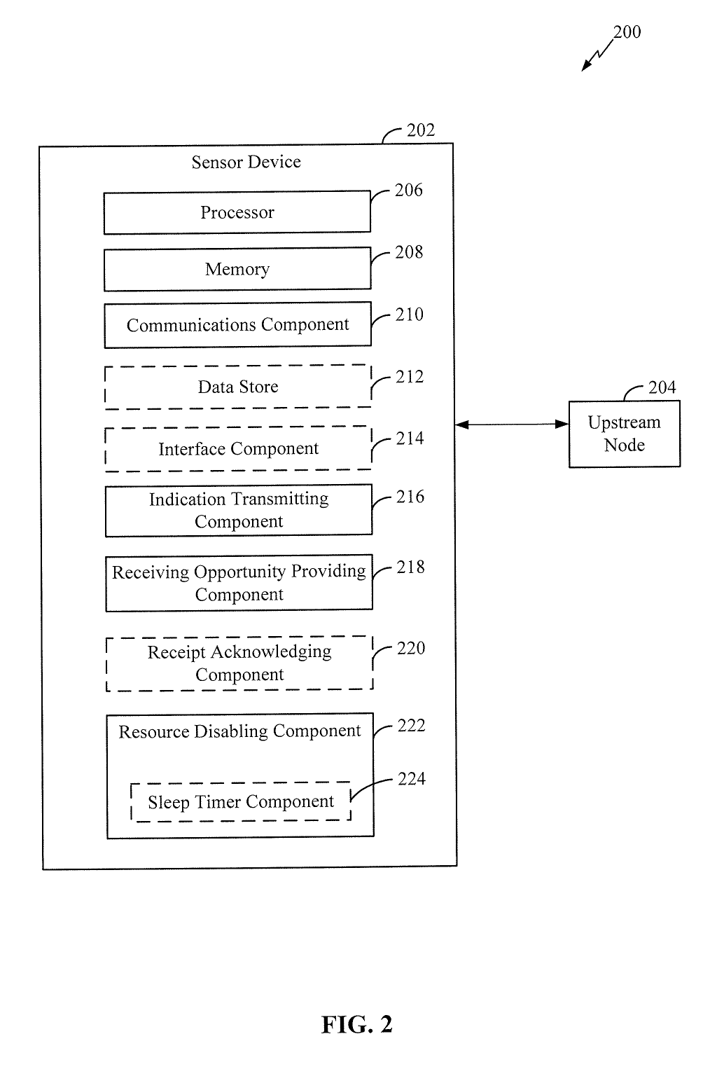

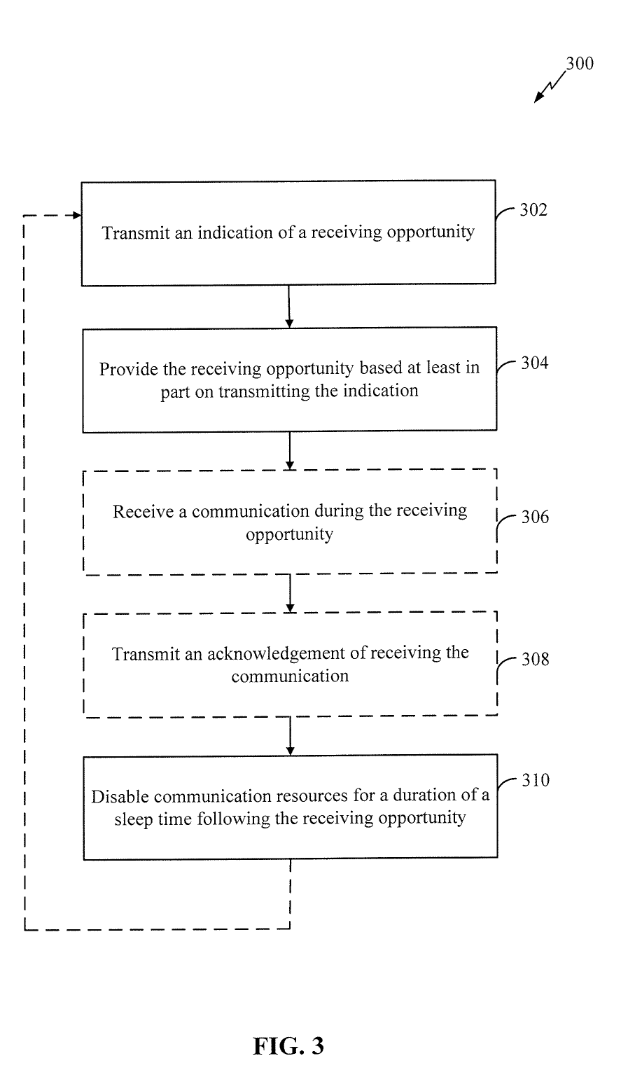

FIGS. 2 and 3 depict an example of an aspect of a sensor device (e.g., sensor device 102, 104, 106, 108, or 110 in FIG. 1) and one or more operations with reference to one or more components and one or more methods that may perform the actions or functions described herein. Although the operations described below in FIG. 3 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

In a particular aspect, a system 200 (FIG. 2) is illustrated for communicating in a sensor network. System 200 includes a sensor device 202 that communicates with an upstream node 204 to participate in the sensor network. For example, sensor device 202 can be a leaf node in a sensor network, such as sensor devices 102, 104, 106, 108, 110 of sensor network 100 of FIG. 1. Further, upstream node 204 can be any of relay nodes 112, 114, 116, or sink node 118 of FIG. 1. Thus, sensor device 202 can operate to communicate information to and/or receive configuration or other information from other nodes in the sensor network, such as upstream node 204. Upstream node 204 can include one or more relay nodes, a sink node, etc., such as relay nodes 112, 114, 116, sink node 118, etc. in sensor network 100 of FIG. 1, for providing information to sensor devices in the sensor network. In one example, sensor device 202 may operate via a battery or other powered component that may have a limited power providing life whereas the upstream node 204 may operate via a more consistent power source, such as a power outlet. In this regard, power conservation at sensor device 202 can be more of a concern than at upstream node 204.

Sensor device 202 may include a processor 206 for carrying out processing functions associated with one or more of the components and functions described herein. Processor 206 can include a single or multiple set of processors or multi-core processors. Moreover, processor 206 can be implemented as an integrated processing system and/or a distributed processing system.

Sensor device 202 further includes a memory 208, such as for storing data or instructions related to functions described herein that may be executed by processor 206. Memory 208 can include any type of memory usable by a computer, such as random access memory (RAM), read only memory (ROM), tapes, magnetic discs, optical discs, volatile memory, non-volatile memory, and any combination thereof.

Further, sensor device 202 may include a communications component 210 that can establish and maintain communications with one or more parties utilizing hardware, software, and services as described herein. Communications component 210 may carry communications between components on sensor device 202, as well as between sensor device 202 and external devices, such as devices located across a sensor network and/or devices serially or locally connected to sensor device 202. For example, communications component 210 may include one or more buses, and may further include transmit chain components and receive chain components associated with a transmitter and receiver, respectively (not shown), operable for interfacing with external devices such as upstream node 204 using one or more communication technologies.

Additionally, sensor device 202 may optionally include a data store 212, which can be any suitable combination of hardware and/or software, that provides for mass storage of information, databases, and programs employed in connection with aspects described herein. For example, data store 212 may be a data repository for applications not currently being executed by processor 206. In some aspects, data store 212 may be located within memory 208.

Sensor device 202 may additionally optionally include an interface component 214 operable to receive inputs (e.g., as a graphical user interface (GUI) with elements for inputting information, as an application programming interface (API) with functions allowing for specifying inputs, etc.), and may be further operable to generate outputs (e.g., for display on the GUI, as a return from an API call, etc.). Interface component 214 may include one or more input devices, including but not limited to a keyboard, a number pad, a mouse, a touch-sensitive display, a navigation key, a function key, a microphone, a voice recognition component, a still camera, a video camera, an audio recorder, and/or any other mechanism capable of receiving an input, or any combination thereof. Further, interface component 214 may include one or more output devices, including but not limited to a display, a speaker, a haptic feedback mechanism, a printer, any other mechanism capable of presenting an output, or any combination thereof.

The remaining components of sensor device 202 are described in conjunction with example operations presented in FIG. 3. While illustrated and described as separate components, it should be noted that the following components may be integral with or a part of one or any combination of processor 206, memory 208, or communications component 210. FIG. 3 depicts a method 300 of wireless communication that includes, at Block 302, transmitting an indication of a receiving opportunity. For example, sensor device 202 can include an indication transmitting component 216 for transmitting the indication of the receiving opportunity in the sensor network 200. Indication transmitting component 216 can transmit the indication to one or more upstream nodes 204, which can include utilizing the communications component 210 o transmit the indication. In this regard, for example, sensor device 202 can have established session-based communications with the upstream node 204 in the sensor network using one or more wired or wireless communication technologies, as described previously (e.g., BLE, NFC, LAN, etc.). Indication transmitting component 216 can transmit the indication to the one or more upstream nodes 204 as part of the communication session. In one example, the indication can be transmitted as part of an existing message transmitted by the sensor device 202 in certain wireless technologies. The indication, in an example, can be a bit or other value indicated in a field of an existing message (e.g., where the bit relates to an immediate receiving opportunity), such as a keep-alive message, a newly defined message, and/or the like. It is to be appreciated that indication transmitting component 216 can additionally or alternatively broadcast the indication, and upstream node 204 can be configured to receive the broadcast.

In any case, the indication can be used to indicate that the sensor device 202 performs an immediate receiving opportunity such that the upstream node 204 can expect the sensor device 202 to receive communications following transmission of the indication. In another example, the indication may include information related to a receiving opportunity the sensor device 202 may perform in the future, such as a start time (which can be an explicit start time or a time related to the time the indication is transmitted), a duration, and/or the like.

Whether the receiving opportunity occurs immediately after transmission of the indication or based on information in the indication, method 300 includes, at Block 304, providing the receiving opportunity based at least in part on transmitting the indication. For example, sensor device 202 can include a receiving opportunity providing component 218 for providing the receiving opportunity. Receiving opportunity providing component 218 can provide the receiving opportunity immediately after indication transmitting component 216 transmits the indication and/or at a time based on information provided in the indication, as described. In either case, receiving opportunity providing component 218 can activate communication resources that allow for receiving communications from one or more nodes in the sensor network 200, such as upstream node 204. For example, receiving opportunity providing component 218 can activate one or more receive chain components and/or related processors or other resources of communications component 210 to facilitate receiving communications for a period of time according to the communication technologies employed by sensor device 202.

A duration of the receiving opportunity, for instance, can be a limited period of time configured at the sensor device 202 (e.g., by hardcoding, received network configuration, and/or the like). In one example, this duration may be specified in the indication transmitted by indication transmitting component 216. In one example, receiving opportunity providing component 218 can receive the duration from the upstream node 204 in a prior communication, where the upstream node 204 can configure aspects of the receiving opportunity provided by the sensor device 202. In an case, the duration can be on the order of milliseconds and can be less than a typical receiving opportunity is one or more wireless technologies to facilitate power conservation at the sensor device 202.

Method 300 optionally includes, at Block 306, receiving a communication during the receiving opportunity. For instance, the communications component 210 can receive communications from upstream node 204 during the provided receiving opportunity. The communications, as described, can relate to configuring operation of the sensor device 202, controlling the sensor device 202 to perform one or more functions (e.g., power on or off), other information related to the upstream node 204, sensor network 200, sensor device 202, other devices or nodes in the sensor network 200, etc., and/or the like, and processor 206 may perform the one or more functions based on the communications.

Method 300 optionally includes, at Block 308, transmitting an acknowledgement of receiving the communication. For instance, sensor device 202 optionally includes a receipt acknowledging component 220 for generating an acknowledgement of receiving the communication for sending to upstream node 204 via communications component 210. In one example, receipt acknowledging component 220 can generate and transmit the acknowledgement immediately after receiving the communication, once the receiving opportunity provided by receiving opportunity providing component 218 has ended, etc. In addition, for example, receipt acknowledging component 220 can send the acknowledgement to the upstream node 204 based on whether communications component 210 properly received and/or is able to decode or otherwise process the communication received from upstream node 204.

Method 300 also includes, at Block 310, disabling communication resources for a duration of a sleep time following the receiving opportunity. For instance, sensor device 202 can include a resource disabling component 222 for disabling the communication resources for the duration of the sleep time. Resource disabling component 222 can thus include a sleep timer component 224 for initializing and managing a sleep timer set to the duration of the sleep time. In this example, resource disabling component 222 can initialize the sleep timer component 224 to begin the timer for the sleep time, and can disable, limit, or otherwise suspend communication resources of the sensor device during the duration of the sleep time. For example, communications component 210 can power down the transmitter and/or receiver chains, corresponding processors, and/or the like during the sleep time to conserve power at sensor device 202.

In one example, resource disabling component 222 can initiate the sleep timer component 224 after receiving opportunity providing component 218 is finished providing the receiving opportunity, though receipt acknowledging component 220 may still transmit an acknowledgment during the duration of the sleep time. In this example, resource disabling component 222 can await transmission of the acknowledgment before suspending communication resources for the remainder of the sleep time. Moreover, for example, the sleep time can be on the order of seconds (e.g., 10 seconds), in one example, and may depend on the power specifications of the sensor device 202 itself. In an example, the sleep time can also be configured by the upstream node 204 (e.g., in a communication from the upstream node 204). The upstream node 204 can configure the sleep time along with the duration of the receiving opportunity, in one example. Likewise, in an example, the upstream node 204 may configure operation of the sensor device 202 to utilize the optimizations described herein (e.g., transmitting an indication of a receiving opportunity followed by disabling communication resources), as described.

After the duration of the sleep time, method 300 can include returning to Block 302 to transmit the indication of a subsequent receiving opportunity. For example, sleep timer component 224 of sensor device 202 can determine expiration of the sleep time, for example, and indication transmitting component 216 can then accordingly transmit the indication, and thus sensor device 202 can repeat the method 300. In this regard, sensor device 202 provides shortened receiving opportunities following indication of the opportunity transmitted in the sensor network (e.g., to upstream node 204), which can result in more efficient use of the receiving resources of the sensor device 202, and thus improved power efficiency.

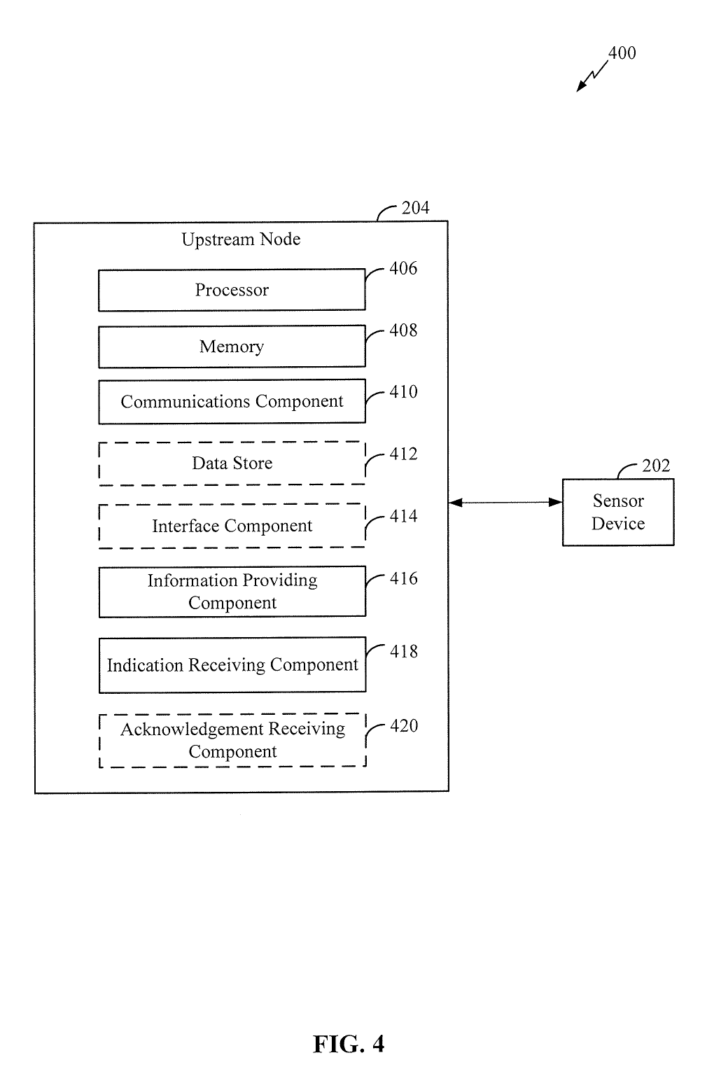

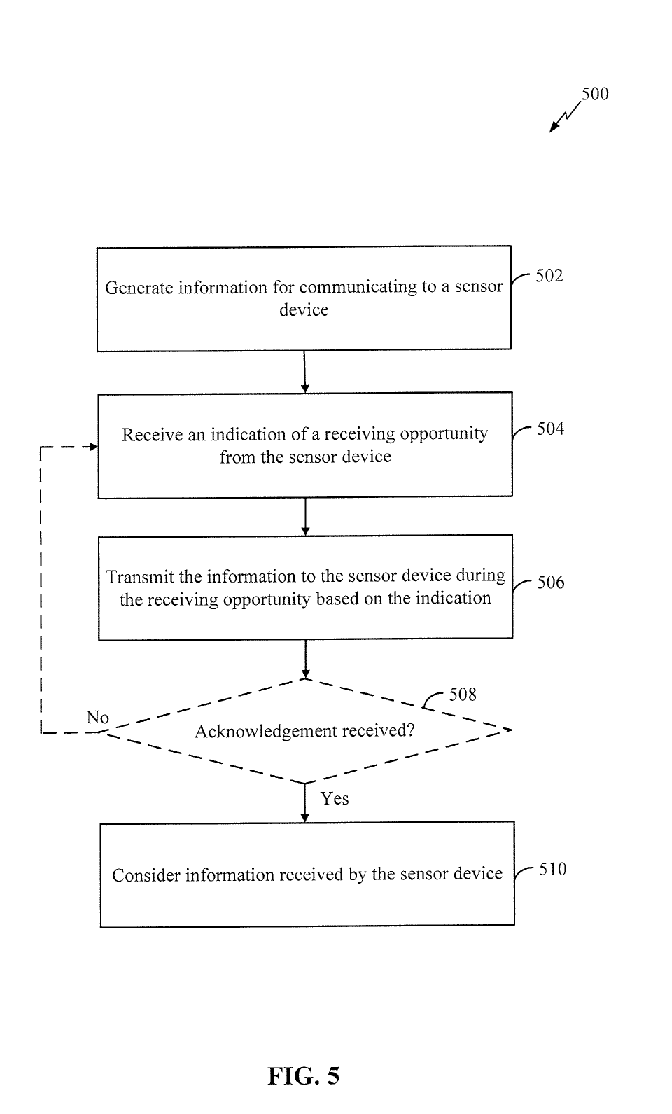

FIGS. 4 and 5 depict an example of an aspect of an upstream node 204 (e.g., relay nodes 112, 114, 116, and/or sink node 118 in FIG. 1, or upstream node 204 of FIG. 2) and one or more operations with reference to one or more components and one or more methods that may perform the actions or functions described herein. Although the operations described below in FIG. 5 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

In a particular aspect, a system 400 (FIG. 4) is illustrated for communicating in a sensor network. System 400 includes an upstream node 204 that communicates with a sensor device 202, e.g., to configure the sensor device 202, to receive information from the sensor device 202, or to exchange any other communications related to participating in the sensor network 400. For example, upstream node 204 can include one or more relay nodes, a sink node, etc., such as relay nodes 112, 114, 116, sink node 118, etc. in sensor network 100 of FIG. 1, for providing information to sensor devices in the sensor network. Sensor device 202 can be a leaf node in a sensor network, such as sensor devices 102, 104, 106, 108, 110 of sensor network 100 of FIG. 1 or sensor device 202 of FIG. 2. In one example, sensor device 202 may operate via a battery or other powered component that may have a limited power providing life whereas the upstream node 204 may operate via a more consistent power source, such as a power outlet. In this regard, power conservation at sensor device 202 can be more of a concern than at upstream node 204, as described.

Upstream node 204 may include a processor 406 for carrying out processing functions associated with one or more of the components and functions described herein. Processor 406 can include a single or multiple set of processors or multi-core processors. Moreover, processor 406 can be implemented as an integrated processing system and/or a distributed processing system.

Upstream node 204 further includes a memory 408, such as for storing data or instructions related to functions described herein being executed by processor 406. Memory 408 can include any type of memory usable by a computer, such as random access memory (RAM), read only memory (ROM), tapes, magnetic discs, optical discs, volatile memory, non-volatile memory, and any combination thereof.

Further, upstream node 204 may include a communications component 410 that can establish and maintain communications with one or more parties utilizing hardware, software, and services as described herein. Communications component 410 may carry communications between components on upstream node 204, as well as between upstream node 204 and external devices, such as devices located across a sensor network and/or devices serially or locally connected to upstream node 204. For example, communications component 410 may include one or more buses, and may further include transmit chain components and receive chain components associated with a transmitter and receiver, respectively (not shown), operable for interfacing with external devices such as sensor device 202 using one or more communication technologies.

Additionally, upstream node 204 may optionally include a data store 412, which can be any suitable combination of hardware and/or software, that provides for mass storage of information, databases, and programs employed in connection with aspects described herein. For example, data store 412 may be a data repository for applications not currently being executed by processor 406. In some aspects, data store 412 may be located within memory 408.

Upstream node 204 may additionally optionally include an interface component 414 operable to receive inputs (e.g., as a GUI with elements for inputting information, as an API with functions allowing for specifying inputs, etc.), and may be further operable to generate outputs (e.g., for display on the GUI, as a return from an API call, etc.). Interface component 414 may include one or more input devices, including but not limited to a keyboard, a number pad, a mouse, a touch-sensitive display, a navigation key, a function key, a microphone, a voice recognition component, a still camera, a video camera, an audio recorder, and/or any other mechanism capable of receiving an input, or any combination thereof. Further, interface component 414 may include one or more output devices, including but not limited to a display, a speaker, a haptic feedback mechanism, a printer, any other mechanism capable of presenting an output, or any combination thereof.

The remaining components of upstream node 204 are described in conjunction with example operations presented in FIG. 5. While illustrated and described as separate components, it should be noted that the following components may be integral with or a part of one or any combination of processor 406, memory 408, or communications component 410. FIG. 5 depicts a method 500 of wireless communication that includes, at Block 502, generating information for communicating to a sensor device. For example, upstream node 204 can include an information providing component 416 for generating the information and transmitting the information to the sensor device 202 at an appropriate time. The information can include configuration information for the sensor device 202, commands for controlling the sensor device 202, information regarding the sensor network 400 and/or devices participating in the network 400, and/or the like. As described, for example, upstream node 204 can wait to receive an indication of a receiving opportunity from the sensor device 202 before transmitting the information. In one example, information providing component 416 can configure sensor device 202 to operate using the optimizations described herein, and can thus transmit information to the sensor device 202 to specify a sleep time duration, a receiving opportunity duration and/or periodicity, etc.

Method 500 includes, at Block 504, receiving an indication of a receiving opportunity from the sensor device. Upstream node 204 can include an indication receiving component 418 for obtaining the indication of the receiving opportunity. As described, the indication can be broadcasted by sensor device 202 and received by indication receiving component 418 in a broadcast message, or can be sent to upstream node 204 over a communication session established therewith, etc. The sensor device 202 can sent the indication, for example, in one or more bits or other values of a message, which can be an existing message in an associated wireless technology (e.g., such as a keep-alive message). The indication can indicate an immediate receiving opportunity and/or can specify details of a future receiving opportunity, such as a start time (e.g., explicit or relative to a current time or time at which the indication is transmitted), a duration, and/or the like.

As described, for example, the upstream node 204 can be set to continuously operate in a receive mode such to receive communications in the sensor network. Since this upstream node 204 is typically connected to an outlet or similar persistent power source, power conservation may not be as large of a concern as it is for the sensor device 202, and thus remaining in the receive mode is possible. Indication receiving component 418 can receive the indication of the receiving opportunity while operating in the continuous receive mode at the upstream node 204.

Method 500 further includes, at Block 506, transmitting the information to the sensor device during the receiving opportunity based on the indication. Information providing component 416 can transmit the information to the sensor device 202 during the receiving opportunity via communications component 410. As described, this can include the information providing component 416 waiting for the indication from the sensor node 202, and then transmitting the information immediately after receiving the indication. In another example, this can include transmitting the information based on one or more parameters specified in the indication, such as a start time, duration, etc. of the receiving opportunity such that the information is received at the sensor device 202 during the receiving opportunity.

Method 500 optionally includes, at Block 508, determining whether an acknowledgement is received for the transmitted information. Upstream node 204 optionally includes an acknowledgement receiving component 420 to receive the acknowledgement and/or determine whether the acknowledgement is received. If the acknowledgement is received at Block 508, then the method 500 can include considering the information is received by the sensor device at Block 510. This can include, for example, information providing component 416 considering the information as received such that the information providing component 416 need not retransmit the information to the sensor device 202, indicate an error in transmitting the information, and/or the like. If the acknowledgement is not received at Block 508 (or at least is not received within a specified period of time during which the acknowledgement is expected), the method can proceed to Block 504 to receive an indication of another receiving opportunity from the sensor device, during which the information can be retransmitted at Block 506. In certain examples. this may continue until an acknowledgment is received at Block 508, for a specified number of attempts, and/or the like.

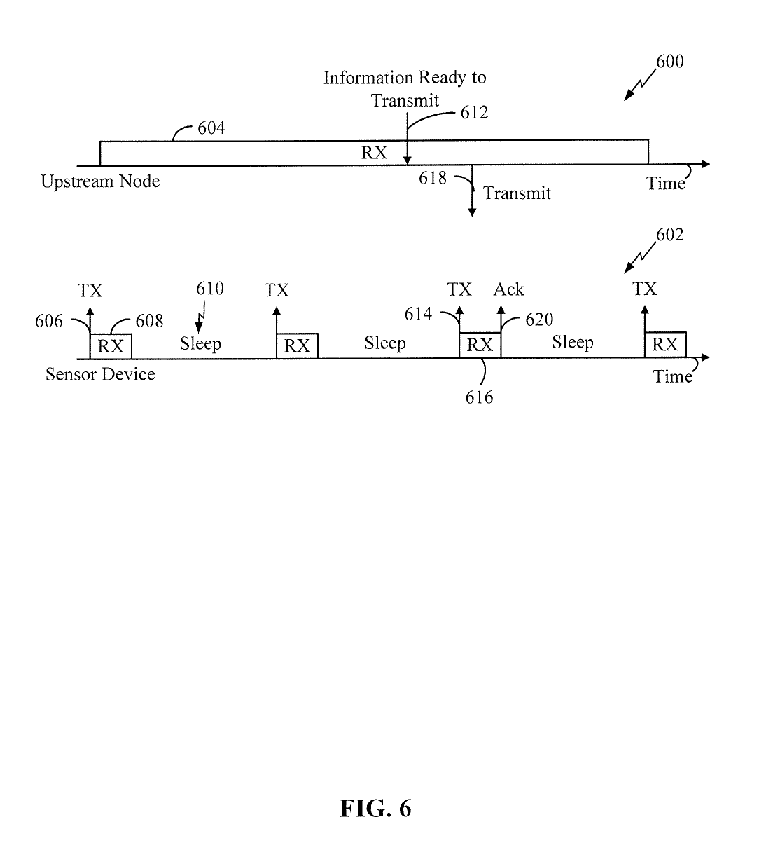

FIG. 6 illustrates example communication timelines 600 and 602 for an upstream node and a sensor device, respectively. For example, the sensor device of FIG. 6 may be the same as or similar to any of sensor devices 102, 104, 106, 108, 110, or 202 described above. Similarly, the upstream node of FIG. 6 may be the same as or similar to any of relay node 112, 114, 116, sink node 118, or upstream node 204 described above. As described, the upstream node can be set to continuously operate in a receive mode such to receive communications in the sensor network, as shown at 604 on timeline 600. Because the upstream node is typically powered using an outlet or other persistent power source, power consumption is not as much of a concern as for battery-powered devices, and the upstream node can be configured in a continuous receive mode 604 without significant concern for the longevity of the node. The sensor device, on the other hand, can attempt to conserve power by transmitting an indication, at 608 in timeline 602, of a shortened receiving opportunity, shown at 608 in timeline 602. In this regard, the upstream node can receive a plurality of periodic indications of related receiving opportunities based on receiving the transmission from the sensor device. As described, the receiving opportunity can occur immediately following the transmission (as shown), a fixed time following the transmission, at a time indicated in the transmitted indication, and/or the like. Following the receiving opportunity, the sensor device can sleep for a duration of a sleep time, as shown at 610 on timeline 602.

In this regard, when the upstream node generates or otherwise acquires information ready to transmit, shown at 612 on timeline 600, the upstream node can wait to transmit the information in a receiving opportunity for the sensor device. In this example, the upstream node waits until it receives a transmission from the sensor device indicating a receiving opportunity, such as transmission 614 indicating an immediate receiving opportunity 616 on timeline 602. Accordingly, the upstream node can transmit the information, shown at 618 on timeline 600, based on receiving the transmission 614. The sensor device can receive the transmission during the receiving opportunity 616. In addition, for example, the sensor device may transmit an acknowledgement of receiving the information, shown at 620 on timeline 602. It is to be appreciated, in an example, that the sensor device can transmit the acknowledgement 620 immediately following the receiving opportunity (which may be required where the sensor device employs a half-duplex radio) or at another time.

Various aspects are described herein in connection with a device or node, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, node, a sensor, or user equipment (UE). Various aspects or features are presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as peer-to-peer (e.g., mobile-to-mobile) ad hoc network systems often using unpaired unlicensed spectrums, 802.xx wireless LAN, BLUETOOTH and any other short- or long-range, wireless communication techniques. In addition, it is to be appreciated that the techniques can be used in conjunction with code division multiple access (CDMA), time division multiple access (TDMA), frequency division multiple access (FDMA), orthogonal frequency division multiple access (OFDMA), single carrier FDMA (SC-FDMA) and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2).

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for communicating in a sensor network, comprising:
transmitting, by a sensor device, an indication of a receiving opportunity at the sensor device;
providing the receiving opportunity at the sensor device based at least in part on transmitting the indication; and
disabling communication resources at the sensor device for a duration of a sleep time following the receiving opportunity.

2. The method of claim 1, further comprising:
transmitting a subsequent indication of a subsequent receiving opportunity at the sensor device following the duration of the sleep time;
providing the subsequent receiving opportunity at the sensor device based at least in part on transmitting the subsequent indication; and
disabling the communication resources at the sensor device for the duration of the sleep time following the subsequent receiving opportunity.

3. The method of claim 2, further comprising initializing a timer for the duration of the sleep time following providing the receiving opportunity, wherein transmitting the subsequent indication of the subsequent receiving opportunity is based at least in part on expiration of the timer.

4. The method of claim 1, further comprising receiving a communication from an upstream node during the receiving opportunity, wherein transmitting the indication comprises transmitting the indication to the upstream node.

5. The method of claim 4, wherein the communication from the upstream node comprises configuration information for operating the sensor device.

6. The method of claim 4, further comprising transmitting an acknowledgement of receiving the communication to the upstream node before disabling the communication resources.

7. The method of claim 4, further comprising receiving a communication from the upstream node indicating the duration of the sleep time or a duration of the receiving opportunity.

8. The method of claim 1, wherein providing the receiving opportunity comprises providing the receiving opportunity for a limited period of time immediately following transmitting the indication.

9. The method of claim 1, wherein the indication includes information regarding the receiving opportunity, and wherein providing the receiving opportunity is based at least in part on the information.

10. The method of claim 9, wherein the information comprises a start time or a duration for the receiving opportunity.

11. An apparatus for communicating in a sensor network, comprising:
an indication transmitting component operable for transmitting an indication of a receiving opportunity at a sensor device;
a receiving opportunity providing component operable for providing the receiving opportunity at the sensor device based at least in part on the indication transmitting component transmitting the indication; and
a resource disabling component operable for disabling communication resources at the sensor device for a duration of a sleep time following the receiving opportunity.

12. The apparatus of claim 11, wherein the indication transmitting component is further operable for transmitting a subsequent indication of a subsequent receiving opportunity at the sensor device following the duration of the sleep time, the receiving opportunity providing component is further operable for providing the subsequent receiving opportunity at the sensor device based at least in part on transmitting the subsequent indication, and the resource disabling component is further operable for disabling the communication resources at the sensor device for the duration of the sleep time following the subsequent receiving opportunity.

13. The apparatus of claim 12, further comprising a sleep timer component operable for initializing a timer for the duration of the sleep time following providing the receiving opportunity, wherein the indication transmitting component is operable for transmitting the subsequent indication of the subsequent receiving opportunity based at least in part on expiration of the timer.

14. The apparatus of claim 11, further comprising a communications component operable for receiving a communication from an upstream node during the receiving opportunity, wherein the indication transmitting component is operable for transmitting the indication to the upstream node.

15. The apparatus of claim 14, wherein the communication from the upstream node comprises configuration information for operating the sensor device.

16. The apparatus of claim 14, further comprising a receipt acknowledging component operable for transmitting an acknowledgement of receiving the communication to the upstream node before disabling the communication resources.

17. The apparatus of claim 14, wherein the communications component is further operable for receiving a communication from the upstream node indicating the duration of the sleep time or a duration of the receiving opportunity.

18. The apparatus of claim 11, wherein the receiving opportunity providing component is operable for providing the receiving opportunity for a limited period of time immediately following transmitting the indication.

19. The apparatus of claim 11, wherein the indication includes a start time or a duration regarding the receiving opportunity, and wherein the receiving opportunity providing component is operable for providing the receiving opportunity based at least in part on the start time or the duration.

20. A method for communicating in a sensor network, comprising:
generating, by a node, information for communicating to a sensor device;
receiving an indication of a receiving opportunity from the sensor device; and
transmitting the information to the sensor device during the receiving opportunity based at least in part on receiving the indication.

21. The method of claim 20, further comprising continuously operating in a receive mode to receive communications in the sensor network, and wherein receiving the indication is part of receiving a plurality of periodic indications from the sensor device while operating in the receive mode.

22. The method of claim 20, wherein the information includes configuration information for the sensor device.

23. The method of claim 20, further comprising transmitting a duration of a sleep time or a duration of the receiving opportunity to the sensor device to facilitate configuring the sensor device to provide the receiving opportunity.

24. The method of claim 20, further comprising receiving an acknowledgement of receiving the information from the sensor device.

25. The method of claim 20, further comprising:
determining that an acknowledgment is not received from the sensor device for receiving the information;
receiving a subsequent indication of a subsequent receiving opportunity from the sensor device; and
retransmitting the information to the sensor device during the subsequent receiving opportunity based at least in part on receiving the subsequent indication and determining that the acknowledgement is not received.

26. An apparatus for communicating in a sensor network, comprising:
an information providing component operable for generating information for communicating to a sensor device;
an indication receiving component operable for receiving an indication of a receiving opportunity from the sensor device; and
a communications component operable for transmitting the information to the sensor device during the receiving opportunity based at least in part on receiving the indication.

27. The apparatus of claim 26, wherein the communications component is operable for continuously operating in a receive mode to receive communications in the sensor network, and wherein the indication receiving component is operable for receiving the indication as part of a plurality of periodic indications received from the sensor device while operating in the receive mode.

28. The apparatus of claim 26, wherein the information includes configuration information for the sensor device.

29. The apparatus of claim 26, wherein the information providing component is further operable for transmitting a duration of a sleep time or a duration of the receiving opportunity to the sensor device to facilitate configuring the sensor device to provide the receiving opportunity.

30. The apparatus of claim 26, further comprising an acknowledgement receiving component operable for determining whether an acknowledgment is received from the sensor device for receiving the information, wherein the indication receiving component is further operable for receiving a subsequent indication of a subsequent receiving opportunity from the sensor device, and the communications component is further operable for retransmitting the information to the sensor device during the subsequent receiving opportunity based at least in part on receiving the subsequent indication where the acknowledgement is not received.
